(19) United States
(12) Patent Application Publication
(10) Pub. No.: US 2017/0223035 A1
(43) Pub. Date: Aug. 3, 2017

(54) SCALING METHOD AND MANAGEMENT DEVICE

(71) Applicant: FUJITSU LIMITED, Kawasaki-shi (JP)

(72) Inventor: Naotoshi WATANABE, Yokohama (JP)

(73) Assignee: FUJITSU LIMITED, Kawasaki-shi (JP)

(21) Appl. No.: 15/414,198

(22) Filed: Jan. 24, 2017

(30) Foreign Application Priority Data
Feb. 2, 2016 (JP) 2016-018369

(51) Int. Cl. H04L 29/06; H04L 12/24

(52) U.S. Cl. CPC H04L 63/1416; H04L 41/064; H04L 41/0672; H04L 63/1458; H04L 12/4641

(57) ABSTRACT

A scaling method executed by a processor included in a management device that manages one or more first virtual networks formed in one or more physical servers, the scaling method includes receiving a notification on a network attack from a second virtual network that defends against the network attack and that is provided in a front stage of the one or more first virtual networks; and reducing a number of resources allocated in the one or more physical servers for the one or more first virtual networks when the notification is received.

### CROSS-REFERENCE TO RELATED APPLICATION

This application is based upon and claims the benefit of priority of the prior Japanese Patent Application No. 2016-018369, filed on Feb. 2, 2016, the entire contents of which are incorporated herein by reference.

### FIELD

The embodiment discussed herein is related to scaling methods and management devices.

### BACKGROUND

Network function virtualization (NFV) technology that forms various network functions in a general-purpose server or the like in a virtual manner by using an application is known (see, for example, Japanese Laid-open Patent Publication No. 2015-149578). Since NFV technology makes it possible to implement a network function without the necessity of using dedicated hardware, the cost of a network system is expected to be reduced. Standardization of NFV technology is being pursued in the European Telecommunications Standards Institute (ETSI).

In NFV technology, a virtual network function (VNF) is formed in one or more physical servers. On the virtual network function, as is the case with cloud technology, for example, scaling that allocates resources such as a central processing unit (CPU), a memory, and so forth in accordance with the load of processing (see, for example, Japanese Laid-open Patent Publication No. 2011-90594 and Japanese Laid-open Patent Publication No. 2011-118525) is performed. For instance, if the traffic of an object to be processed by the virtual network function increases or usage of the resource that processes the traffic increases, scale out by which the number of allocated resources is increased is performed; if the traffic of the object to be processed by the virtual network function reduces or usage of the resource that processes the traffic reduces, scale in by which the number of allocated resources is reduced is performed.

If the virtual network function is under a network attack such as a Distributed Denial of Service (DDoS) attack, the traffic of the object to be processed thereby increases. As a result, scale out is performed and the number of resources to be allocated increases. In response to the network attack, a security appliance such as a firewall or an intrusion prevention system (IPS) filters malicious traffic by creating an appropriate signature. This reduces the traffic of the object to be processed by the virtual network function.

However, even when the traffic of the object to be processed reduces, scale in is not immediately performed on the virtual network function. In order to avoid scale out and scale in from being repeatedly performed, a monitoring time, for example, which monitors another increase in the traffic has to be provided before scale in is performed. As a result, for example, if a charge system in accordance with the utilization time and the resource amount is applied in service that offers the virtual network function, the user of the service is forced to spend money wastefully due to a network attack until scale in is performed. In light of the above situation, it is desirable to reduce promptly the number of resources that has increased in response to the network attack.

### SUMMARY

According to an aspect of the invention, a scaling method executed by a processor included in a management device that manages one or more first virtual networks formed in one or more physical servers, the scaling method includes receiving a notification on a network attack from a second virtual network that defends against the network attack and that is provided in a front stage of the one or more first virtual networks; and reducing a number of resources allocated in the one or more physical servers for the one or more first virtual networks when the notification is received.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram depicting an example of a virtual network system;

FIG. 2 is a diagram depicting an example of operation of a virtual network function at the time of a network attack;

FIG. 3 is a sequence diagram depicting a comparative example of operation of the virtual network system;

FIG. 4 is a sequence diagram depicting an embodiment of operation of the virtual network system;

FIG. 5 is a configuration diagram depicting an example of a virtual network function management server;

FIGS. 6A and 6B are diagrams (I) depicting an example of configuration management information;

FIG. 7 is a diagram (II) depicting an example of the configuration management information;

FIG. 8 is a diagram (III) depicting an example of the configuration management information;

FIGS. 9A and 9B are diagrams (I) depicting an example of scaling history information;

FIGS. 10A and 10B are diagrams (II) depicting an example of the scaling history information;

FIG. 11 is a flowchart depicting an example of processing of a scaling management portion;

FIG. 12 is a flowchart depicting an example of processing of a network function virtualization controlling portion; and

FIG. 13 is a flowchart depicting an application example of session movement processing.

### DESCRIPTION OF EMBODIMENT

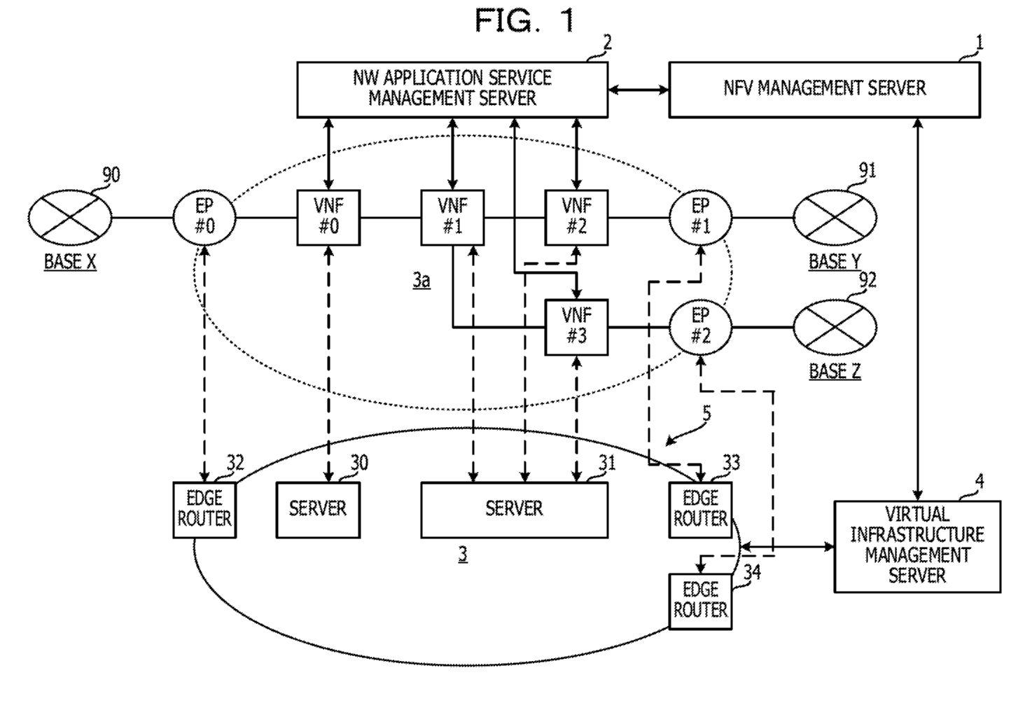

FIG. 1 is a configuration diagram depicting an example of a virtual network system. The virtual network system includes a network function virtualization (NFV) management server 1, a network (NW) application service management server 2, a virtual network 3a, and a virtual infrastructure management server 4. Of these components, the NFV management server 1, the NW application service management server 2, and the virtual infrastructure management server 4 form a management system for the virtual network 3a.

The virtual network 3a includes end points (EPs) #0 to #2, each being an end point of the virtual network 3a, and VNFs #0 to #3 which are network functions formed in a virtual manner. For example, the EP #0 is connected to a LAN 90 of a company's base X. The EP #1 is connected to a LAN 91 of a company's base Y. The EP #2 is connected to a LAN 92 of a company's base Z.

The EP #0 is connected to the VNF #0. The EP #1 is connected to the VNF #2. The EP #2 is connected to the VNF #3. The VNF #1 is connected to the other VNFs #0, #2, and #3.

The virtual network 3a is formed in a virtual manner by a physical network 3 including physical servers 30 and 31 and edge routers 32 to 34 which form a virtual/physical infrastructure 5. Dotted arrows indicate a correspondence between the physical servers 30 and 31 and the edge routers 32 to 34 and the VNFs #0 to #2 and the EPs #0 to #2.

The EPs #0 to #2 correspond to the edge routers 32 to 34. The VNF #0 corresponds to the physical server 30. The VNFs #1 to #3 correspond to the physical server 31. That is, the VNF #0 is a network function formed in the physical server 30 in a virtual manner. The VNFs #1 to #3 are network functions formed in the physical server 31 in a virtual manner. The VNFs #0 to #3 are each formed of an application that executes a network function in the physical servers 30 and 31.

The NW application service management server 2 is an example of a second management device and manages service that is offered by the applications of the VNFs #0 to #3. The NW application service management server 2 performs various managements in cooperation with the NFV management server 1.

The NFV management server 1 is an example of a first management device and manages the VNFs #0 to #3. More specifically, the NFV management server 1 manages the resources by performing scaling of the VNFs #0 to #3 in cooperation with the NW application service management server 2 and the virtual infrastructure management server 4. The virtual infrastructure management server 4 manages the virtual/physical infrastructure 5.

With this virtual network system, it is possible to implement a network function with the general-purpose physical servers 30 and 31, for example, without the necessity of using dedicated hardware. This makes it possible to implement communication service among the LANs 90 to 92 of the companies at low cost. However, as will be described later, if the virtual network system is under a network attack (hereinafter written as an “NW attack”) such as a DDoS attack, scale out is performed on the VNFs #1 to #3 with an increase in traffic caused by the NW attack. This undesirably forces the user to spend money wastefully.

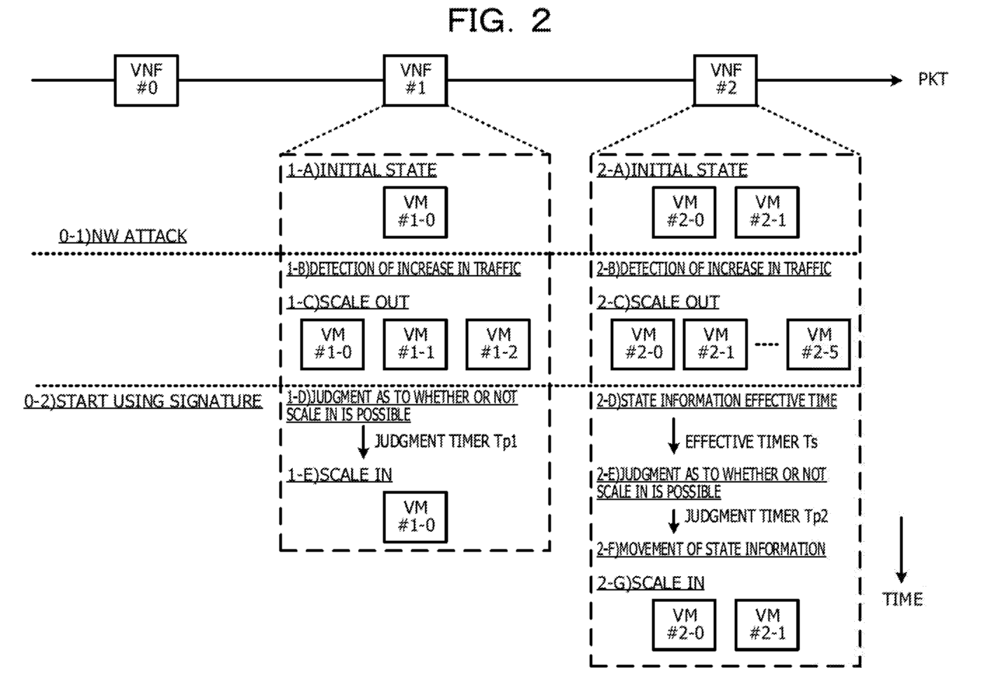

FIG. 2 depicts an example of operation of the VNFs #0 to #2 at the time of an NW attack. In this example, the VNF #0 is provided in a front stage of the VNFs #1 and #2. The VNF #0 is an application that implements a security appliance such as a firewall or an IPS.

The VNF #1 is executed by a stateless application that does not have state information for each communication session. The VNF #2 is executed by a stateful application having state information. A packet PKT that is used in an NW attack passes through the VNFs #0 to #2 in this order.

In an initial state before the NW attack, the VNF #1 includes, as a resource, a VM #1-0 which is a virtual machine (VM) and the VNF #2 includes, as a resource, a VM #2-0 and a VM #2-1 which are virtual machines (steps 1-A and 2-A). As the resource, a container may be used in place of the VM.

When the NW attack occurs (step 0-1), the NFV management server 1 detects an increase in the number of packets of the VNFs #1 and #2 caused by the NW attack, that is, an increase in the traffic (steps 1-B and 2-B). It is impossible for the NFV management server 1 to recognize that an increase in the traffic was caused by the NW attack.

When detecting an increase in the traffic of the VNFs #1 and #2, the NFV management server 1 performs scale out on the VNFs #1 and #2 so as to make it possible to process the increased traffic appropriately (steps 1-C and 2-C). As a result, for example, to the VNF #1, a VM #1-1 and a VM #1-2 are added as a resource. To the VNF #2, VMs #2-2 to #2-5 are added as a resource.

Then, in order to defend against the NW attack, the VNF #0 creates a signature for filtering the packet PKT that is making the NW attack and starts using the signature (step 0-2). As a result, the traffic of the VNFs #1 and #2 reduces.

However, even when the traffic reduces, scale in is not immediately performed on the VNFs #1 and #2. The NFV management server 1 judges whether or not scale in may be performed on the VNF #1 by using a judgment timer whose expiration time is Tp1 (step 1-D).

More specifically, in order to avoid scale out and scale in from being repeatedly performed, the NFV management server 1 monitors another increase in traffic until the judgment timer reaches the expiration time. When the judgment timer reaches the expiration time, the NFV management server 1 judges that scale in is possible and performs scale in on the VNF #1 (step 1-E). This reduces the number of resources of the VNF #1 until the VNF #1 has only the VM #1-0, for example.

On the other hand, as for the VNF #2, even when the traffic flow caused by the NW attack ceases and the amount of reception of traffic reduces, the state information for the traffic caused by the NW attack is maintained. After a reduction in the traffic, after a lapse of a time that elapses before the state information held by each of the VMs #2-0 to #2-5 is deleted without being used (a “state information effective time”), the state information for the traffic caused by the NW attack is deleted. The NFV management server 1 judges a reduction in the state information or a reduction in the memory usage associated with the reduction in the state information as a trigger to perform scale in (step 2-D). That is, it is impossible for the NFV management server 1 to recognize a trigger to perform scale in for each of the VMs #2-0 to #2-5 until the effective timer whose expiration time is Ts reaches the expiration time, which brings the NFV management server 1 in a standby state.

After the effective timer reaches the expiration time, the NFV management server 1 judges whether or not scale in may be performed by using a judgment timer whose expiration time is Tp2 as performed on the VNF #1 (step 2-E). If the NFV management server 1 judges that scale in may be performed, the NW application service management server 2 moves the state information of a VM of the VMs #2-0 to #2-5 of the VNF #2, the VM which is to be deleted by scale in, to the other VMs (step 2-F).

After the movement of the state information, the NFV management server 1 performs scale in on the VNF #2 (step 2-G). This reduces the number of resources of the VNF #2 until the VNF #2 has only the VM #2-0 and the VM #2-1, for example.

As described above, there is a necessity for the time for judging whether or not scale in may be performed until scale in is performed on the VNF #1. In addition, there is a necessity for the effective time of the state information, the time for judging whether or not scale in may be performed, and the state information movement time until scale in is performed on the VNF #2.

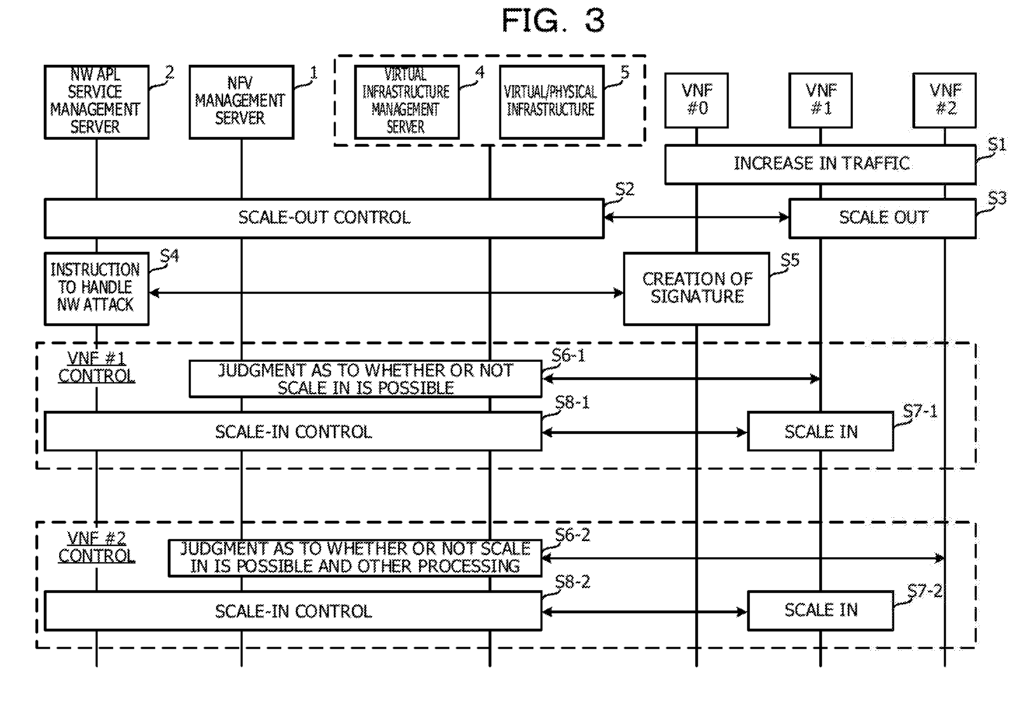

FIG. 3 is a sequence diagram depicting a comparative example of operation of the virtual network system. In FIG. 3, the NW application service management server is written as the “NW APL service management server”. When an NW attack occurs, the traffic of the VNFs #0 to #2 increases (see reference character S1). At this time, it is possible for the NW application service management server 2 and the VNF #0 to detect the NW attack. However, it is impossible for the NFV management server 1, the virtual infrastructure management server 4, the virtual/physical infrastructure 5, and the VNFs #1 and #2 to recognize the NW attack.

The NFV management server 1 performs scale-out control of the VNFs #1 and #2 in response to an increase in traffic in cooperation with the NW application service management server 2, the virtual infrastructure management server 4, and the virtual/physical infrastructure 5 (see reference character S2). As a result, scale out is performed on the VNFs #1 and #2 (see reference character S3).

The NW application service management server 2 gives an instruction to the VNF #0 to handle the NW attack (see reference character S4). In accordance with the instruction, the VNF #0 creates a signature for filtering the packet PKT making the NW attack and starts using the signature (see reference character S5). Alternatively, the VNF #0 receives an instruction including a new signature from the NW application service management server 2, sets that signature as a signature, and starts using the signature. Hereinafter, control of the VNF #1 and control of the VNF #2 (see dotted frames) are performed concurrently.

In control of the VNF #1, the NFV management server 1 makes a judgment as to whether or not scale in may be performed on the VNF #1, which corresponds to step 1-D of FIG. 2, in cooperation with the virtual infrastructure management server 4 and the virtual/physical infrastructure 5 (see reference character S6-1). If the NFV management server 1 judges that scale in is possible, the NFV management server 1 performs scale-in control in cooperation with the NW application service management server 2, the virtual infrastructure management server 4, and the virtual/physical infrastructure 5 (reference character S8-1). As a result, scale in is performed on the VNF #1 (reference character S7-1).

On the other hand, in control of the VNF #2, the NFV management server 1 performs a judgment as to whether or not scale in may be performed on the VNF #2 and other processing, which corresponds to steps 2-D to 2-F of FIG. 2, in cooperation with the virtual infrastructure management server 4 and the virtual/physical infrastructure 5 (see reference character S6-2). If the NFV management server 1 judges that scale in is possible, when the state information movement processing and so forth are completed, the NFV management server 1 performs scale-in control in cooperation with the NW application service management server 2, the virtual infrastructure management server 4, and the virtual/physical infrastructure 5 (reference character S8-2). As a result, scale in is performed on the VNF #2 (reference character S7-2). In this way, the virtual network system operates.

As described above, in the virtual network system, when the traffic increases due to the occurrence of an NW attack, after the traffic reduces as a result of the NW attack being handled, there is a necessity for, for example, the time for judging whether or not scale in may be performed until scale in is performed on the VNFs #1 and #2. As a result, for example, if a charge system in accordance with the utilization time and the resource amount is applied in service that offers the VNFs #1 and #2, the user of the service is forced to spend money wastefully due to an NW attack until scale in is performed.

It is for this reason that the NFV management server 1 of the embodiment receives a notification on an NW attack and identifies, based on the notification, a VNF on which scale out has been performed in response to the NW attack. Then, by shortening the time interval between scale out and scale in which is performed on the VNF, the NFV management server 1 promptly reduces the number of resources that has increased in response to the NW attack. More specifically, the NFV management server 1 receives an NW attack notification from the NW application service management server 2 or the VNF #0. Then, for the VNFs #1 and #2 identified based on the NW attack notification, the NFV management server 1 shortens the expiration times Tp1 and Tp2 of the judgment timers and the expiration time Ts of the effective timer for the state information.

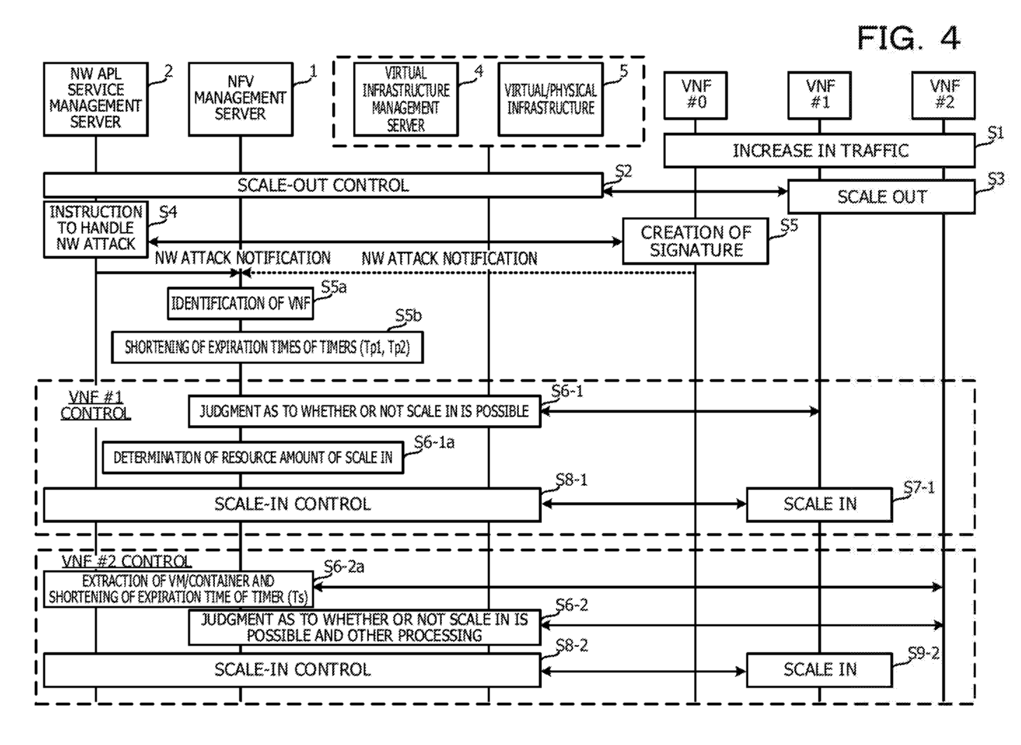

FIG. 4 is a sequence diagram depicting the embodiment of operation of the virtual network system. In FIG. 4, such operations as are found also in FIG. 3 will be identified with the same reference characters and explanations thereof will be omitted.

After giving an instruction to handle an NW attack (see reference character S4), the NW application service management server 2 transmits an NW attack notification to the NFV management server 1. The NW attack notification is an example of a notification on an NW attack. The NW attack notification includes, for example, information such as an ID of the user who is under the NW attack, a service ID, a direction in which the packet PKT flows, and a start time of an NW attack.

In place of the NW application service management server 2, the VNF #0 that handles the NW attack may transmit the NW attack notification to the NFV management server 1 (see a dotted arrow). The VNF #0 is an example of an application that defends the VNFs #1 and #2 against the NW attack.

Based on the received NW attack notification, the NFV management server 1 identifies, of the VNFs #0 to #3 in the virtual network 3a, the VNFs #1 and #2 on which scale out has been performed in response to an increase in the traffic caused by the NW attack (see reference character S5a). The details of this identification method will be described later.

The NFV management server 1 shortens the expiration times Tp1 and Tp2 of the judgment timers of the identified VNFs #1 and #2 (reference character S5b). That is, the NFV management server 1 shortens the time interval between scale out and scale in which is performed on the identified VNFs #1 and #2. As a result, the time for judging whether or not scale in is possible in steps 1-D and 2-E of FIG. 2 is shortened.

In control of the VNF #1, after making a judgment as to whether or not scale in is possible (reference character S6-1), the NFV management server 1 determines a resource amount to be reduced by scale in which is performed on the VNF #1 based on the resource amount or the traffic processing amount of the VNF #1 at the start time of the NW attack (see reference character S6-1a). This makes it possible to determine promptly the allocated resource amount of the VNF #1 after scale in and return the value to a value before the NW attack. In the past, in order to avoid excessive scale in, reduction has been performed in predetermined resource amounts. However, in that case, if the resources that are used to handle the traffic caused by the NW attack are greater than that resource amount, a plurality of scale-in operations are performed in stages. On the other hand, in the present embodiment, it is possible to perform scale in quickly to a size corresponding to the allocated resource amount after that scale in. Then, scale in is performed on the VNF #1 (S8-1 and S7-1).

In control of the VNF #2, the NFV management server 1 extracts a VM or container containing many communication sessions related to an NW attack. Then, for the extracted VM or container, the NFV management server 1 shortens the expiration time Ts of the effective timer for the state information (S6-2a). That is, for the extracted VM or container, the NFV management server 1 sets a short effective time of the state information through the NW application service management server 2 or, if the NFV management server 1 has a direct interface to the VNF #1, the NFV management server 1 itself sets the short effective time of the state information. As a result, the effective time of the state information in step 2-D of FIG. 2 is shortened. Then, a judgment as to whether or not scale in may be performed on the VNF #2 and other processing and scale in are performed (S6-2, S8-2, and S9-2).

As described above, when receiving an NW attack notification, the NFV management server 1 reduces the number of resources allocated to the VNFs #1 and #2, which are objects to be managed, by performing scale in. This makes it possible for the NFV management server 1 of the embodiment to reduce promptly the number of resources which has increased in response to the NW attack. Next, the configuration of the NFV management server 1 will be described.

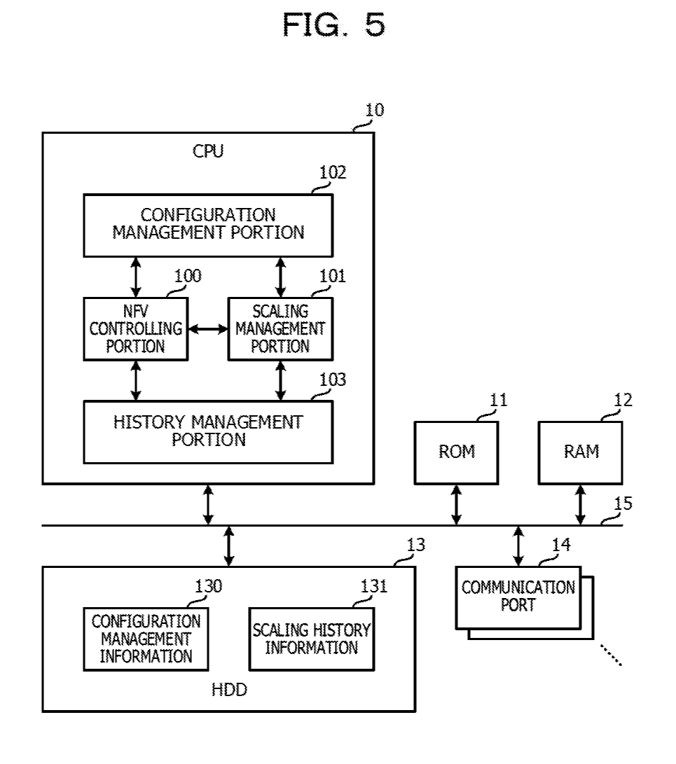

FIG. 5 is a configuration diagram depicting an example of the NFV management server 1. The NFV management server 1 includes a central processing unit (CPU) 10, read-only memory (ROM) 11, random-access memory (RAM) 12, a hard disk drive (HDD) 13, and a plurality of communication ports 14. The CPU 10 is connected to the ROM 11, the RAM 12, the HDD 13, and the plurality of communication ports 14 via a data bus 15 in such a way that it is possible to perform input and output of signals therebetween.

The ROM 11 stores a program that drives the CPU 10. The RAM 12 functions as working memory of the CPU 10. The communication ports 14 are, for example, physical layer (PHY)/media access control (MAC) devices. The communication ports 14 transmit and receive packets between the NW application service management server 2 and the virtual infrastructure management server 4. Examples of the packets include an Internet Protocol (IP) packet, but the packets are not limited thereto.

The communication ports 14 are each an example of a receiving portion. The communication ports 14 receive an NW attack notification from the VNF #0 or the NW application service management server 2. As in FIG. 1, if the NFV management server 1 does not have a direct interface to the VNF #0, the communication ports 14 communicate with the VNF #0 (that is, the server 30) via the NW application service management server 2 in order to receive the NW attack notification from the VNF #0.

When the CPU 10 reads the program from the ROM 11, an NFV controlling portion 100, a scaling management portion 101, a configuration management portion 102, and a history management portion 103 are formed as functions. In the HDD 13, configuration management information 130 and scaling history information 131 are stored. As a unit for storing the configuration management information 130 and the scaling history information 131, a nonvolatile memory or the like may be used in place of the HDD 13.

As will be described later, the configuration management information 130 includes, for each user ID, information on the connection configuration of the VNFs #0 to #3 corresponding to each service ID, the flow in the virtual network 3a, and the configuration and the resource of each of the VNFs #0 to #3. The scaling history information 131 includes, for each user ID, information on the history of scaling of each of the VNFs #0 to #3.

The scaling management portion 101 is an example of a scaling portion. As described earlier, when receiving an NW attack notification via the communication ports 14, the scaling management portion 101 reduces the number of resources allocated to the VNFs #1 and #2 which are objects to be managed. When the traffic of the objects to be processed of the VNFs #1 to #3 increases, the scaling management portion 101 performs scale out on the VNFs #1 to #3, and, when the traffic of the objects to be processed reduces, the scaling management portion 101 performs scale in on the VNFs #1 to #3 after a time interval. More specifically, as described earlier with reference to FIGS. 2 to 4, the scaling management portion 101 performs scale out on the VNFs #1 to #3 in response to an increase in traffic irrespective of whether or not an NW attack was made. Then, the scaling management portion 101 performs scale in on the VNFs #1 to #3 after the judgment timer for judging whether or not scale in is possible reaches the expiration time.

The NFV controlling portion 100 is an example of a controlling portion. Based on the NW attack notification, the NFV controlling portion 100 identifies, of the VNFs #1 to #3, the VNFs #1 and #2 on which scale out has been performed by the scaling management portion 101 in response to an increase in traffic caused by the NW attack. More specifically, the NFV controlling portion 100 obtains the user ID and the service ID from the NW attack notification. Then, based on the user ID and the service ID, the NFV controlling portion 100 searches the configuration management information 130 for the connection configuration of the VNFs #0 to #3. Then, based on the connection configuration thus obtained, the NFV controlling portion 100 identifies the VNFs #1 and #2 on which scale out has been performed. The configuration of the configuration management information 130 will be described later.

The NFV controlling portion 100 shortens the time interval between scale out and scale in which is performed on the identified VNFs #1 and #2 by the scaling management portion 101. More specifically, the NFV controlling portion 100 shortens the expiration times Tp1 and Tp2 of the judgment timers of the VNFs #1 and #2. This makes it possible for the NFV controlling portion 100 to shorten the time interval between scale out and scale in which is performed by the scaling management portion 101 when the traffic of the VNFs #1 and #2 on which scale out has been performed due to the NW attack reduces. As will be described later, the expiration times Tp1 and Tp2 of the judgment timers are included in the configuration management information 130.

More specifically, as described earlier, the scaling management portion 101 makes a judgment as to whether or not scale in is possible when the traffic reduces irrespective of whether or not a cause of an increase in traffic is an NW attack. On the other hand, the NFV controlling portion 100 identifies the VNFs #1 and #2 whose traffic has increased due to an NW attack based on the NW attack notification and shortens the expiration times Tp1 and Tp2 of the judgment timers of the VNFs #1 and #2. As a result, if no NW attack occurs, that is, if the scaling management portion 101 does not receive an NW attack notification, assuming that the expiration times Tp1 and Tp2 of the judgment timers are each a predetermined value TA (an example of a first time), for example, the scaling management portion 101 performs scale in on the VNFs #1 and #2 after a lapse of the predetermined value TA. On the other hand, if an NW attack occurs, that is, if the scaling management portion 101 receives an NW attack notification, the scaling management portion 101 performs scale in on the VNFs #1 and #2 after a lapse of another predetermined value TB (<TA) (an example of a second time) which is shorter than the predetermined value TA.

As a result, the scaling management portion 101 makes a judgment as to whether or not scale in is possible by using the judgment timers whose expiration times Tp1 and Tp2 have been shortened. This makes it possible to shorten the time that elapses before scale in is performed on the VNFs #1 and #2 of the VNFs #1 to #3, the VNFs #1 and #2 on which scale out has been performed due to the NW attack.

The NFV controlling portion 100 obtains, from the NW attack notification, time information indicating the start time of the NW attack. The NFV controlling portion 100 determines a VNF of the identified VNFs #1 and #2, the VNF which is executed by a stateless application. Then, the NFV controlling portion 100 determines a resource amount to be reduced by scale in which is performed on the relevant VNF #1 based on the resource amount or the traffic processing amount of the VNF #1 at the start time of the NW attack. At this time, the NFV controlling portion 100 obtains, based on the time information, the resource amount or the traffic processing amount of the VNF #1 at the start time indicated by the time information from the scaling history information 131. The configuration of the scaling history information 131 will be described later.

The scaling management portion 101 performs scale in on the VNF #1 based on the resource amount determined by the NFV controlling portion 100. This makes it possible for the scaling management portion 101 to return the resource amount of the VNF #1 quickly to the value before the NW attack.

The NFV controlling portion 100 determines a VNF of the identified VNFs #1 and #2, the VNF which is executed by a stateless application. Then, the NFV controlling portion 100 compares the effective time of the state information held by the relevant VNF #2 with the elapsed time from the start time of the NW attack. Here, the elapsed time is obtained from a built-in timer of the NFV controlling portion 100 or an external time synchronization server, for example.

If the effective time of the state information is longer than the elapsed time from the start time of the NW attack, the NFV controlling portion 100 extracts, from the VMs or containers included in the VNF #2, the VM or container added to the VNF #2 by scale out performed by the scaling management portion 101 after the start time of the NW attack. In this case, the NFV controlling portion 100 extracts the VM or container added after the start time of the NW attack by regarding the VM or the container as a VM or container containing many communication sessions related to the NW attack.

For the extracted VM or container, the NFV controlling portion 100 shortens the effective time. More specifically, the NFV controlling portion 100 shortens the expiration time Ts of the effective timer of the extracted VM or container. This makes it possible for the NFV controlling portion 100 to invalidate promptly the state information of the relevant VM or container and prepare for scale in. As will be described later, the expiration time Ts of the effective timer is included in the configuration management information 130.

If the effective time of the state information held by the VNF #2 is shorter than or equal to the elapsed time from the start time of the NW attack, the NFV controlling portion 100 extracts, from the VMs or containers included in the VNF #2, the VM or container whose release rate of the state information is greater than or equal to a predetermined value. Here, the release rate of the state information is the ratio of the number of pieces of state information deleted as a result of the effective time having elapsed to the number of all the pieces of state information.

In this case, since the elapsed time from the NW attack is long, in the VMs or containers before the NW attack, communications of communication sessions which are not related to the NW attack are completed. Then, sessions related to the NW attack are allocated to the vacant resources, whereby, in a VM group or a container group which forms the VNF #2, homogeneous mixing of the communication sessions related to the NW attack and other communication sessions proceeds. As a result, since the traffic caused by the NW attack often contains communication sessions whose number is large and whose successful completion is not achieved, the NFV controlling portion 100 extracts the VM or container whose release rate is high by regarding the VM or container as a VM or container containing many communication sessions related to the NW attack. As described earlier, the NFV controlling portion 100 shortens the effective time for the extracted VM or container. This makes it possible for the NFV controlling portion 100 to invalidate promptly the state information of the relevant VM or container and prepare for scale in.

The configuration management portion 102 collects the information on the configurations of the VNFs #0 to #3 and the configurations of the resources of the VNFs #0 to #3 from the NFV controlling portion 100 and the scaling management portion 101. Then, in accordance with the collected information, the configuration management portion 102 updates the configuration management information 130 in the HDD 13. The history management portion 103 collects the information on the scale-in control and the scale-out control from the NFV controlling portion 100 and the scaling management portion 101. Then, in accordance with the collected information, the history management portion 103 updates the scaling history information 131 in the HDD 13. Hereinafter, the configuration management information 130 and the scaling history information 131 will be described.

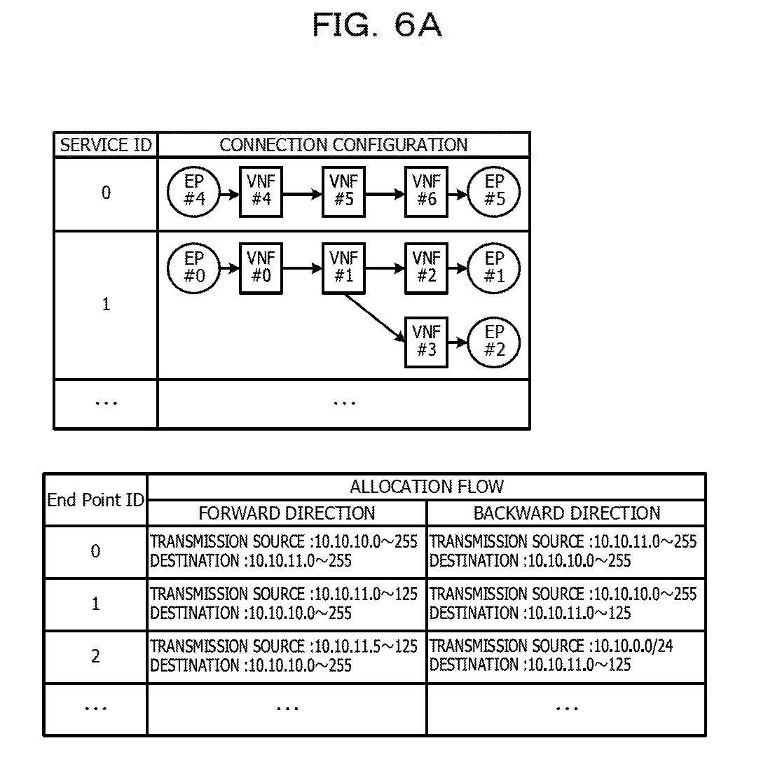

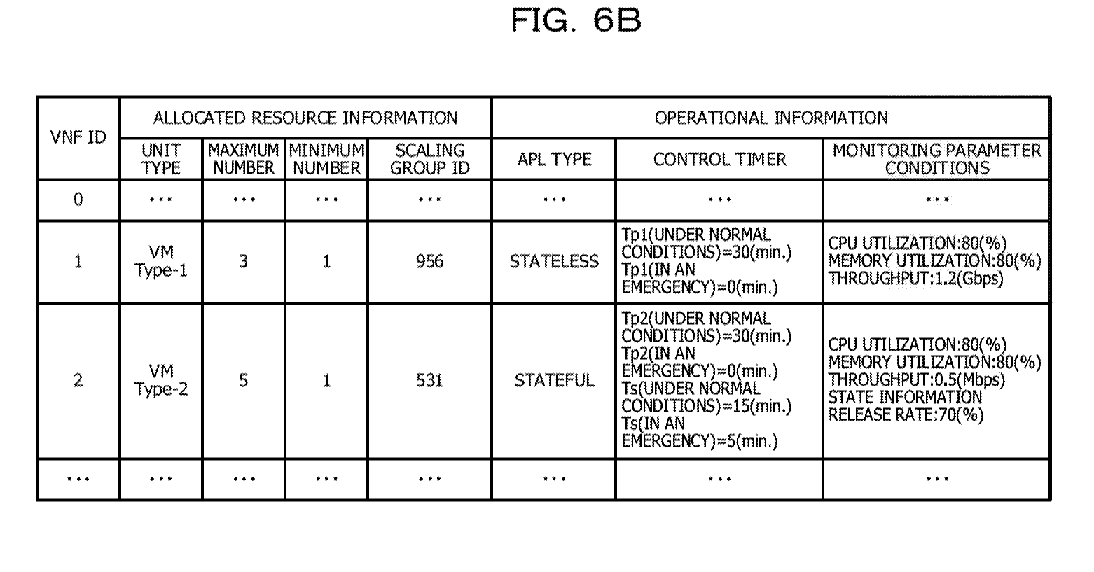

FIGS. 6A to FIG. 8 depict an example of the configuration management information 130. The configuration management information 130 is provided for each user of the virtual network 3a, that is, each of the user IDs indicating the companies at the bases X to Z of FIG. 1. In this example, the configuration management information 130 of the user whose user ID is “#k” (k is a positive integer) is illustrated.

First, with reference to FIGS. 6A and 6B, the configuration management information 130 includes connection configuration information (see FIG. 6A) indicating the connection configuration of the VNFs #0 to #3 in the virtual network 3a in the communication service that is offered to the user and application configuration information (see FIG. 6B) indicating the configurations of the VNFs #0 to #3.

The connection configuration information includes “connection configuration” information indicating the connection of the VNFs between the EPs for each service ID which is an identifier of the communication service and “allocation flow” information indicating the flow of a packet allocated to the communication service for each end point ID which is an identifier of the EP. The connection configuration of the example of FIG. 1 corresponds to the connection configuration whose service ID is “1”. The NFV controlling portion 100 identifies the connection configuration of the example of FIG. 1 based on the user ID “#k” and the service ID “1” included in the NW attack notification.

The “allocation flow” information includes, for each of the flows of a forward direction and a backward direction of an end point, IP addresses of a transmission source and a destination. The NFV controlling portion 100 identifies the flow of the NW attack by searching the “allocation flow” information based on the IP address of the destination included in the NW attack notification.

The application configuration information includes allocated resource information and operational information for each VNF ID (#0, #1, . . . ) which is an identifier of the VNF. The allocated resource information includes a unit type of a resource (a VM or container) which is allocated to the VNF, the maximum and minimum numbers of resources, a scaling group ID indicating a scaling group to which the VNF belongs.

In the case of the example of FIG. 1, the VNF #1 belongs to a group whose scaling group ID is “#956”, and a maximum of three VMs of “VM Type-1” are allocated thereto and a minimum of one VM of “VM Type-1” is allocated thereto. The VNF #2 belongs to a group whose scaling group ID is “#531”, and a maximum of five VMs of “VM Type-2” are allocated thereto and a minimum of one VM of “VM Type-2” is allocated thereto.

The operational information includes the type of an application (APL) of the VNF, setting information of control timers such as the judgment timer and the effective timer, and various monitoring parameter conditions. In the case of the example of FIG. 1, the VNF #1 is of the stateless application type. The VNF #2 is of the stateful application type. The NFV controlling portion 100 determines whether each of the VNFs #1 and #2 is the stateless application or the stateful application based on the information on the APL type.

The setting information of the control timers includes information under normal conditions and information in an emergency for a case where scale out is performed in response to an NW attack. The expiration time of the control timer in an emergency is shorter than the expiration time of the control timer under normal conditions. The NFV controlling portion 100 shortens the time that elapses before scale in is performed on the VNFs #1 and #2 by switching the expiration time of the control timer from the expiration time under normal conditions to the expiration time in an emergency for the VNFs #1 and #2 identified based on the NW attack notification.

For example, the expiration time Tp1 of the judgment timer of the VNF #1 is set at 30 (min.) under normal conditions and is set at 0 (min.) in an emergency. The expiration time Tp2 of the judgment timer of the VNF #2 is set at 30 (min.) under normal conditions and is set at 0 (min.) in an emergency. The scaling management portion 101 controls the judgment timer by the expiration time on which an instruction is given by the NFV controlling portion 100. As a result, the scaling management portion 101 immediately ends a judgment as to whether or not scale in is possible and performs scale in.

The expiration time Ts of the effective timer for the state information, the expiration time Ts of the VM or container which is the resource of the VNF #2, is set at 15 (min.) under normal conditions and is set at 5 (min.) in an emergency. The NFV controlling portion 100 extracts a VM or container containing many communication sessions related to the NW attack. Then, the NFV controlling portion 100 applies the expiration time of the effective timer in an emergency to the extracted VM or container. As a result, the effective time of the state information of the relevant VM or container is shortened.

The monitoring parameter conditions are, for example, judgment values concerning the resources that are used for various controls. As an example, the monitoring parameter conditions of the VNFs #1 and #2 include CPU usage, memory usage, and the throughput of traffic. The monitoring parameter conditions of the VNF #2 include a threshold value for a release rate of the state information that is used by the NFV controlling portion 100 to extract a VM or container.

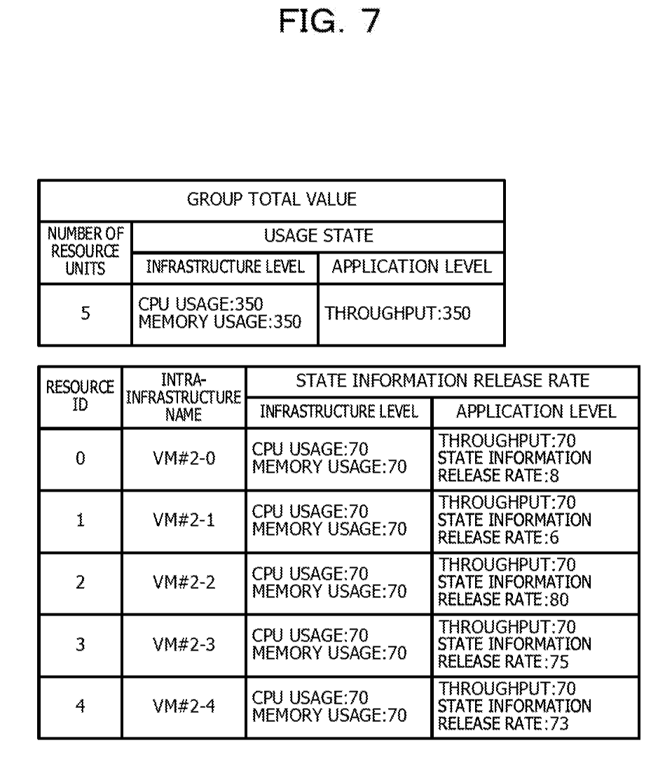

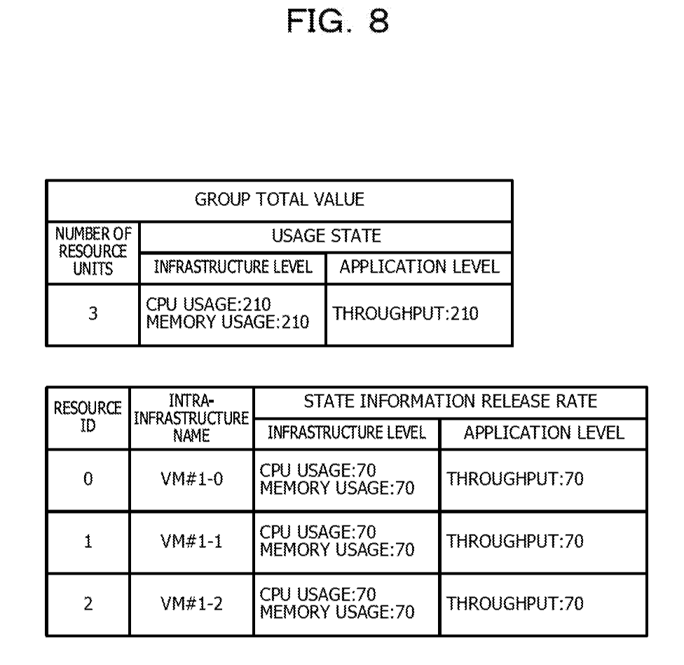

Next, with reference to FIGS. 7 and 8, the configuration management information 130 includes allocated resource configuration information indicating the allocated resource configuration for each of the scaling group IDs of the VNFs #0 to #3. FIG. 7 depicts the allocated resource configuration information of the VNF #2. FIG. 8 depicts the allocated resource configuration information of the VNF #1. The allocated resource configuration information includes a group total value which is the sum total of the resource amount in the group, an intra-infrastructure name which is a name in the virtual/physical infrastructure 5 for each resource ID which is an identifier of the VM or container, and information on the usage state of the resource.

As the usage state of the resource, there are an infrastructure level and an application level. In the infrastructure level, the CPU usage and the memory usage are indicated. In the application level, the throughput of traffic and the release rate of the state information are indicated. The group total value indicates, in addition to the number of resource units, the value obtained by adding up the above-described parameters for all the resources. In this example, an example of various parameters in a case where three resources (VMs or containers) are allocated to the VNF #1 and five resources are allocated to the VNF #2 is depicted.

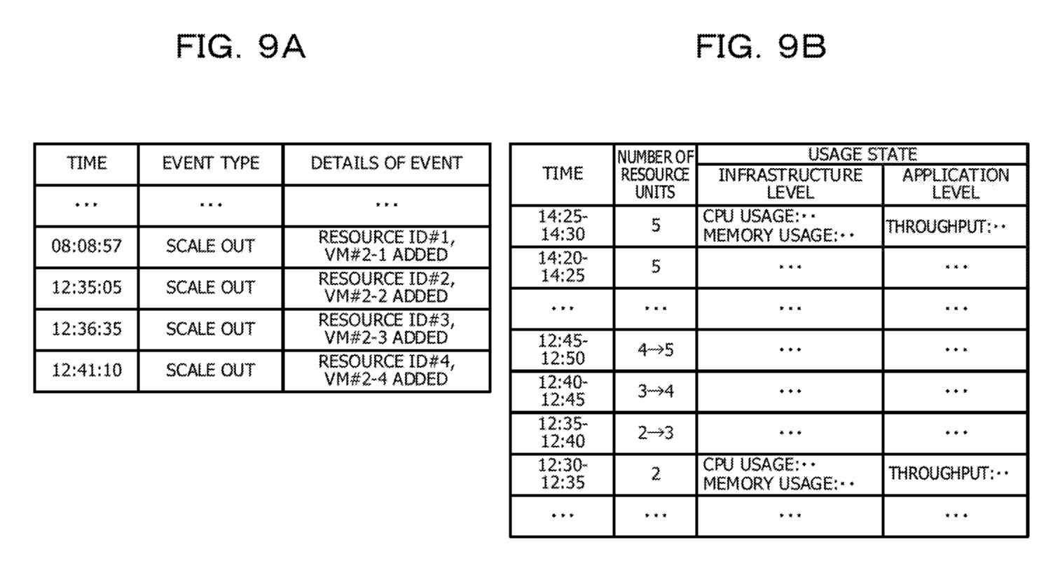

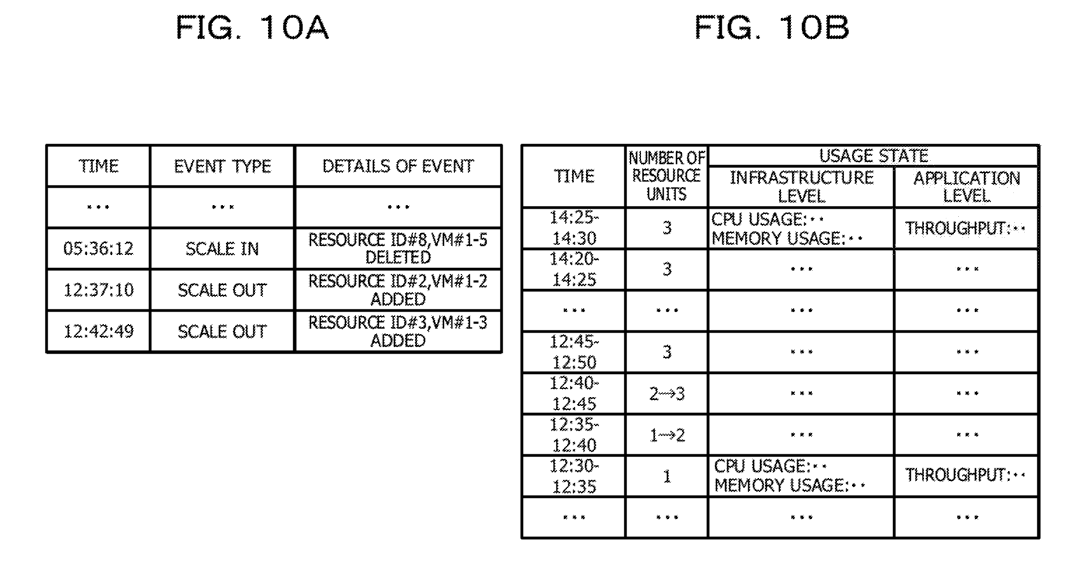

In FIGS. 9A and 9B and FIGS. 10A and 10B, an example of the scaling history information is depicted. The scaling history information includes control history information (see FIGS. 9A and 10A) indicating the control history of scaling for each of the scaling group IDs of the VNFs #0 to #3 and usage state history information (see FIGS. 9B and 10B) indicating the history of the usage state of the resource. FIGS. 9A and 9B depict the scaling history information of the VNF #2. FIGS. 10A and 10B depict the scaling history information of the VNF #1.

The control history information indicates the time at which a scaling control event was performed, the type of the event, and the details of the event. The event type indicates scale in or scale out. The details of the event indicate the resource ID, the intra-infrastructure name, and so forth of a resource on which scale in or scale out is to be performed.

The usage state history information indicates the number of resource units and information on the usage state at fixed time intervals (5 minutes in this example). As the usage state of the resource, as is the case with the allocated resource configuration information, there are an infrastructure level and an application level. In the infrastructure level, CPU usage and memory usage are indicated. In the application level, the throughput of traffic is indicated. Next, an example of scaling control processing will be described.

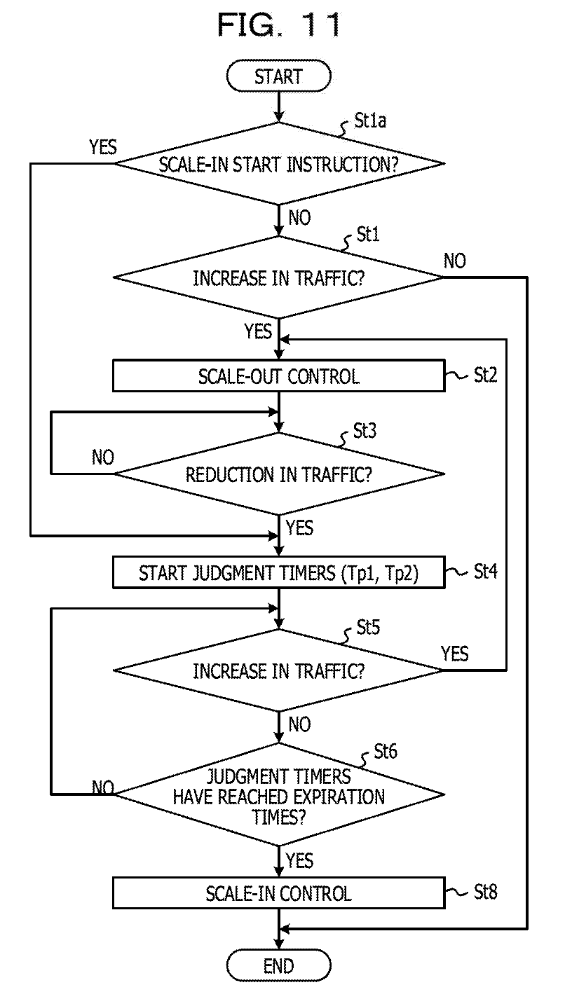

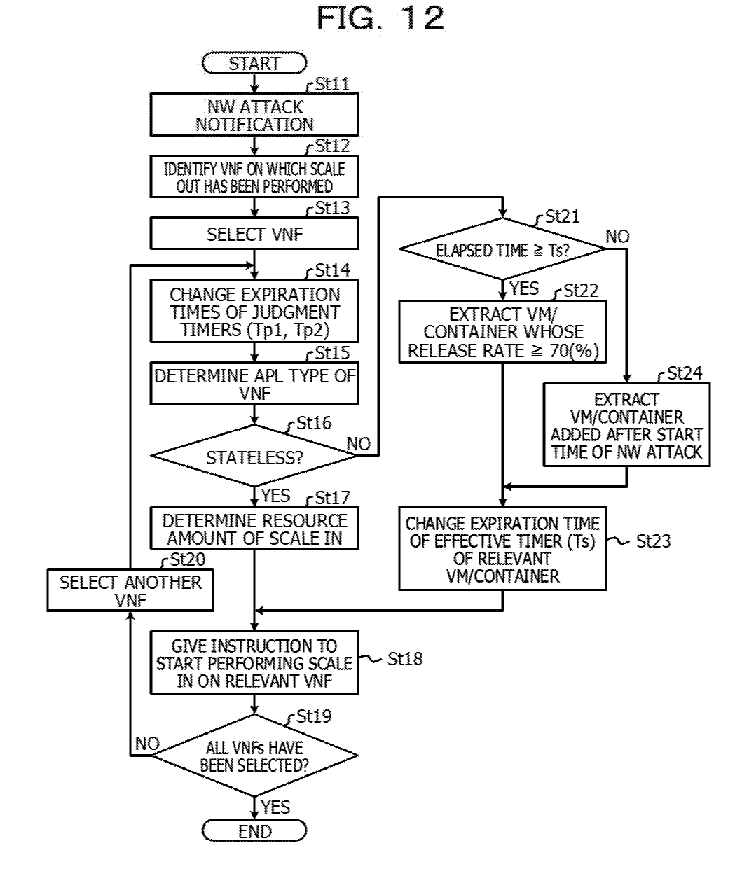

FIG. 11 is a flowchart depicting an example of processing of the scaling management portion 101. This processing is periodically performed, for example. First, the scaling management portion 101 judges the presence or absence of a scale-in start instruction from the NFV controlling portion 100 (St1a). If the scaling management portion 101 receives the scale-in start instruction (Yes in St1a), the scaling management portion 101 starts the judgment timers (whose expiration times are Tp1 and Tp2) of the relevant VNFs #1 and #2 (St4). Next, processing after St5, which will be described later, is performed.

If the scaling management portion 101 does not receive the scale-in start instruction (No in St1a), the scaling management portion 101 judges the presence or absence of an increase in the traffic of the VNFs #0 to #3 in the virtual network 3a (St1). At this time, the scaling management portion 101 obtains the traffic amounts of the VNFs #0 to #3 from the NW application service management server 2, for example. Then, the scaling management portion 101 judges the presence or absence of an increase in the traffic based on the amount of change in the traffic amounts.

If there is no increase in the traffic (No in St1), the scaling management portion 101 ends the processing. If there is an increase in the traffic (Yes in St1), the scaling management portion 101 performs scale-out control on the relevant VNFs #1 and #2 (St2).

Next, the scaling management portion 101 judges the presence or absence of a reduction in the traffic of the relevant VNFs #1 and #2 (St3). At this time, the scaling management portion 101 obtains the traffic amounts of the VNFs #1 and #2 from the NW application service management server 2, for example. Then, the scaling management portion 101 judges the presence or absence of a reduction in the traffic based on the amount of change in the traffic amounts.

If there is no reduction in the traffic (No in St3), the scaling management portion 101 performs the judgment processing in St3 again. If there is a reduction in the traffic (Yes in St3), the scaling management portion 101 starts the judgment timers (whose expiration times are Tp1 and Tp2) of the relevant VNFs #1 and #2 (St4).

Next, the scaling management portion 101 judges the presence or absence of an increase in the traffic of the VNFs #0 to #3 in the virtual network 3a (St5). If there is an increase in the traffic (Yes in St5), the scaling management portion 101 stops the judgment timers and performs the processing in St2 again.

If there is no increase in the traffic (No in St5), the scaling management portion 101 judges whether or not the judgment timers have reached the expiration times (St6). If the judgment timers have not reached the expiration times (No in St6), the scaling management portion 101 performs the judgment processing in St5 again.

If the judgment timers have reached the expiration times (Yes in St6), the scaling management portion 101 performs scale-in control (St8). As described above, when receiving the NW attack notification, the scaling management portion 101 reduces the number of resources allocated to the VNFs #1 and #2. In this way, the scaling management portion 101 performs the processing. Next, processing of the NFV controlling portion 100 will be described.

FIG. 12 is a flowchart depicting an example of the processing of the NFV controlling portion 100. This processing is performed when an NW attack has been made on the virtual network 3a.

First, the NFV controlling portion 100 receives an NW attack notification from the NW application service management server 2 via the communication ports 14 (St11). Next, based on the NW attack notification, the NFV controlling portion 100 identifies, of the VNFs #0 to #3, the VNFs #1 and #2 on which scale out has been performed by the scaling management portion 101 in response to an increase in traffic caused by the NW attack (St12).

At this time, the NFV controlling portion 100 obtains the user ID, the service ID, and the VNF ID (#0) of the VNF #0 that performs defensive processing (such as creation of a signature) against the NW attack which are included in the NW attack notification. Then, the NFV controlling portion 100 identifies the relevant connection configuration by searching the configuration management information 130 based on the obtained information. In the above-described example, the NFV controlling portion 100 obtains the user ID “#k” and the service ID “#1” from the NW attack notification. Then, the NFV controlling portion 100 searches the configuration management information 130 based on that information and identifies the connection configuration of the VNFs #0 to #3 of FIG. 1.

Furthermore, the NFV controlling portion 100 obtains, from the NW attack notification, flow information (a direction, identification information, and so forth) of the traffic on which the defensive processing against the NW attack has been performed. Then, the NFV controlling portion 100 identifies the traffic including the flow of the NW attack based on the allocation flow information by searching the configuration management information 130 based on the obtained information. In the above-described example, the NFV controlling portion 100 performs identification on the assumption that, in the connection configuration of FIG. 1, the traffic from the EP #0 toward the EP #1 includes the flow of the NW attack.

Based on the identified connection configuration and traffic, the NFV controlling portion 100 identifies the VNFs #1 and #2 on which scale out has been performed by the scaling management portion 101 in response to the NW attack.

Next, the NFV controlling portion 100 selects one of the identified VNFs #1 and #2 (St13). The order of selection of the VNFs #1 and #2 is not limited to a particular order.

Next, the NFV controlling portion 100 changes a corresponding one of the expiration times Tp1 and Tp2 of the judgment timer of the selected one of the VNFs #1 and #2 from the expiration time under normal conditions to the expiration time in an emergency of FIG. 6B (St14). As a result, the expiration times Tp1 and Tp2 of the judgment timers are shortened and the time that elapses before scale in is performed in shortened.

Next, the NFV controlling portion 100 determines the APL types of the VNFs #1 and #2 (St15). The NFV controlling portion 100 determines that the VNF #1 is a stateless application and that the VNF #2 is a stateful application.

If the determination result is a stateless application (Yes in St16), that is, if the VNF #1 is selected, the NFV controlling portion 100 performs processing in St17 to St20 which will be described below. If the determination result is a stateful application (No in St16), that is, if the VNF #2 is selected, the NFV controlling portion 100 performs processing in St21 to St24 and St18 to St20 which will be described below.

First, the processing which is performed on the VNF #1 that is a stateless application will be described. Based on the time information included in the NW attack notification, the NFV controlling portion 100 determines the resource amount of scale in which is performed on the VNF #1 (St17). At this time, the NFV controlling portion 100 obtains, from the NW attack notification, the time information indicating the start time of the NW attack. Then, the NFV controlling portion 100 searches the scaling history information 131 for the number of resource units (that is, the resource amount) or the throughput (that is, the traffic processing amount) at the start time of the NW attack.

If the number of resource units is used, the NFV controlling portion 100 determines the number of resource units as the resource amount of scale in. For example, if the start time of the NW attack is 12:28, the NFV controlling portion 100 searches the usage state history information of the VNF #1 for the number of resource units at the time between 12:25 and 12:30. Then, the NFV controlling portion 100 determines the number of resource units obtained by the search as the resource amount of scale in which is performed on the VNF #1. On the other hand, if the throughput is used, the NFV controlling portion 100 determines a value obtained by multiplying the throughput by a predetermined coefficient as the resource amount of scale in.

Next, the NFV controlling portion 100 gives an instruction to the scaling management portion 101 to start performing scale in on the VNF #1 (St18). Next, the NFV controlling portion 100 judges whether or not all the VNFs have been selected (St19). If all the VNFs have been selected (Yes in St19), the NFV controlling portion 100 ends the processing; if there is a VNF which has not yet been selected (No in St19), the NFV controlling portion 100 selects the VNF which has not yet been selected (St20) and performs the processing from St14 again.

Next, the processing which is performed on the VNF #2 which is a stateful application will be described. The NFV controlling portion 100 obtains the start time of the NW attack from the NW attack notification and compares the elapsed time from the start time with the effective time of the state information, that is, the expiration time Ts of the effective timer (St21). If the effective time of the state information is longer than the elapsed time from the start time of the NW attack (No in St21), the NFV controlling portion 100 extracts, from the VMs or containers of the relevant VNF #2, the VM or container added to the VNF #2 by scale out performed by the scaling management portion 101 after the start time of the NW attack (St24).

For example, if the start time of the NW attack is 12:28 and the current time is 12:42, the elapsed time is 14 minutes. In this case, since the effective time of the state information (in this example, 15 minutes (see FIG. 6B)) is longer than the elapsed time, the NFV controlling portion 100 extracts the VMs #2-2 to #2-4 added after 12:28 based on the scaling history information of the VNF #2 depicted in FIGS. 9A and 9B.

If the effective time of the state information is shorter than or equal to the elapsed time from the start time of the NW attack (Yes in St21), the NFV controlling portion 100 extracts, from the VMs or containers of the relevant VNF #2, the VM or container whose release rate of the state information is greater than or equal to a predetermined value (in this example, 70(%) (see FIG. 6B)) (St22).

For example, if the start time of the NW attack is 12:28 and the current time is 14:33, the elapsed time is 2 hours and 5 minutes. In this case, the effective time of the state information (in this example, 15 minutes (see FIG. 6B)) is shorter than the elapsed time. Thus, the NFV controlling portion 100 extracts the VMs #2-2 to #2-4 whose release rate is greater than or equal to 70(%) based on the allocated resource information of the VNF #2 depicted in FIG. 7.

Next, the NFV controlling portion 100 changes the expiration time Ts of the effective timer for the state information of the extracted VM or container from the expiration time under normal conditions to the expiration time in an emergency of FIG. 6B (St23). That is, for the extracted VM or container, the NFV controlling portion 100 shortens the effective time of the state information. As a result, the effective time of the state information is shortened and the time that elapses before scale in is performed is shortened. Then, the processing from St18 to St20 described above is performed. In this way, the processing of the NFV controlling portion 100 is performed.

In this example, the NFV controlling portion 100 shortens the effective time of the VM or container of the VNF #2 which is a stateful application (St23); instead of the above, session movement processing of moving a normal communication session to another resource may be applied. This makes it possible to shorten the time of state information movement processing in step 2-F depicted in FIG. 2.

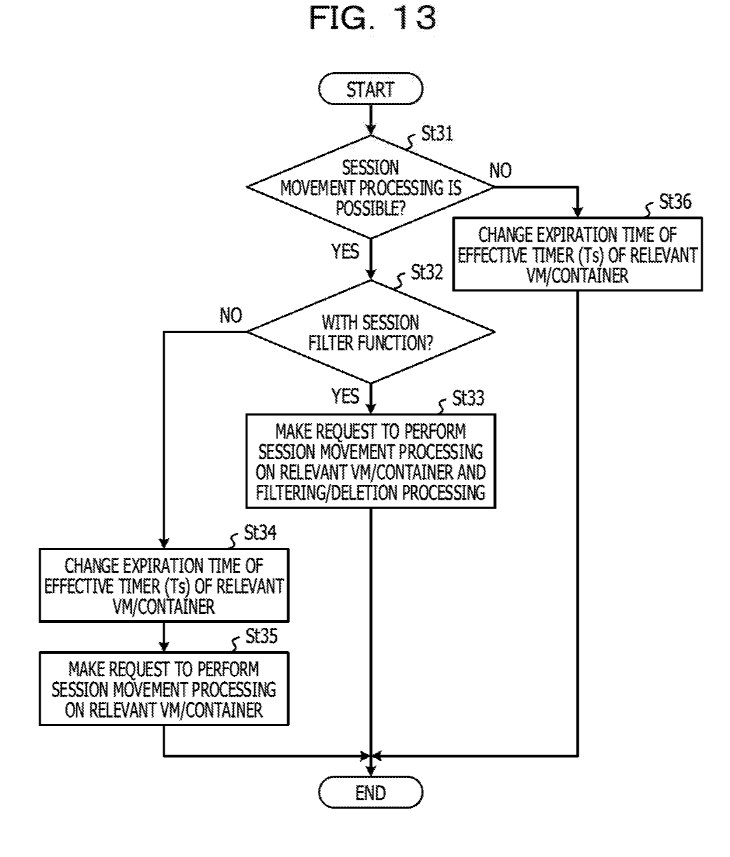

FIG. 13 is a flowchart depicting an application example of the session movement processing. This processing is performed in place of St23 of FIG. 12.

First, the NFV controlling portion 100 judges whether or not the session movement processing by the NW application service management server 2 is possible (St31). That is, the NFV controlling portion 100 judges whether or not support for the session movement processing by the NW application service management server 2 is possible. At this time, the NFV controlling portion 100 makes, via the communication ports 14, for example, an inquiry to the NW application service management server 2 about whether or not the session movement processing is possible.

If the session movement processing is impossible (No in St31), the NFV controlling portion 100 shortens the expiration time Ts of the effective timer of the extracted VM or container (St36). If the session movement processing is possible (Yes in St31), the NFV controlling portion 100 judges whether or not the NW application service management server 2 has a filter function that removes a designated communication session from objects on which the session movement processing is to be performed (St32). At this time, the NFV controlling portion 100 makes, via the communication ports 14, for example, an inquiry to the NW application service management server 2 about whether or not the filter function is possible.

If the NW application service management server 2 has the filter function (Yes in St32), the NFV controlling portion 100 makes a request, to the NW application service management server 2, to perform the session movement processing on the relevant VM or container and filtering/deletion processing of the communication session related to the NW attack (St33). This makes it possible for the NW application service management server 2 to identify the VM or container on which the session movement processing is to be performed and thereby perform prompt session movement processing.

If the NW application service management server 2 does not have the filter function (No in St32), the NFV controlling portion 100 shortens the expiration time Ts of the effective timer of the extracted VM or container (St34). Next, the NFV controlling portion 100 makes a request to the NW application service management server 2 to perform the session movement processing on the relevant VM or container (St35). This makes it possible for the NW application service management server 2 to identify the VM or container on which the session movement processing is to be performed with a communication session movement destination being secured and thereby perform prompt session movement processing. In this way, the session movement processing is performed.

As described above, the NFV management server 1 of the embodiment manages the VNFs #1 and #2 formed in the physical server 31 and has the scaling management portion 101 and the communication ports 14. The communication ports 14 receive the NW attack notification detected by the other VNF #0 that is provided in a front stage of the VNFs #1 and #2 and defends against the NW attack. When receiving the NW attack notification, the scaling management portion 101 reduces the number of resources allocated to the VNFs #1 and #2 which are objects to be managed.

The above-described configuration makes it possible for the scaling management portion 101 to reduce the number of resources allocated to the VNFs #1 and #2 by receiving the NW attack notification. This makes it possible for the NFV management server 1 of the embodiment to reduce promptly the number of resources that has increased in response to the NW attack.

The management system of the embodiment has the NFV management server 1 and the NW application service management server 2. The NFV management server 1 manages the VNFs #1 to #3 formed in the physical server 31. The NW application service management server 2 manages the VNF #0 that is provided in the front stage of the VNFs #1 and #2 and defends against the NW attack.

When detecting the NW attack by the VNF #0, the NW application service management server 2 transmits the NW attack notification to the NFV management server 1. The NFV management server 1 includes the scaling management portion 101 and the communication ports 14.

The communication ports 14 receive the NW attack notification detected by the other VNF #0 that is provided in the front stage of the VNFs #1 and #2 and defends against the NW attack. When receiving the NW attack notification, the scaling management portion 101 reduces the number of resources allocated to the VNFs #1 and #2 which are objects to be managed.

Since the management system of the embodiment includes a configuration similar to the configuration of the NFV management server 1 described above, the management system produces effects similar to those described above.

A scaling method of the embodiment includes the following steps in a scaling method of the virtual network functions formed in the physical server.

Step (1): A notification of an NW attack detected by the VNF #0 that is provided in the front stage of the VNFs #1 and #2 and defends against the NW attack is received.

Step (2): When the NW attack notification is received, the number of resources allocated to the VNFs #1 and #2 which are objects to be managed is reduced.

Since the scaling method according to the embodiment includes a configuration similar to the configuration of the above-described NFV management server 1, the scaling method produces effects similar to those described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A scaling method executed by a processor included in a management device that manages one or more first virtual networks formed in one or more physical servers, the scaling method comprising:
receiving a notification on a network attack from a second virtual network that defends against the network attack and that is provided in a front stage of the one or more first virtual networks; and
reducing a number of resources allocated in the one or more physical servers for the one or more first virtual networks when the notification is received.

2. The scaling method according to claim 1, further comprising:
reducing the number of resources after a lapse of a first time after traffic of an object to be processed by the one or more first virtual networks reduces,
wherein the reducing the number of resources when the notification is received includes reducing the number of resources after a lapse of a second time which is shorter than the first time after the traffic of the object to be processed by the one or more first virtual networks reduces.

3. The scaling method according to claim 1, wherein the reducing of the number of resources includes:
identifying, from the one or more first virtual networks, a plurality of virtual networks whose number of resources has increased in response to an increase in the traffic caused by the network attack, based on the notification,
extracting, from the plurality of virtual networks, one or more virtual networks executed by a stateless application having no state information for each communication session, and
reducing a number of resources allocated in the one or more physical servers for the extracted one or more virtual networks.

4. The scaling method according to claim 3, wherein
the notification includes time information indicating a start time of the network attack, and
the reducing of the number of resources includes:
determining a resource amount which is to be reduced for the extracted one or more virtual networks based on a resource amount or a traffic processing amount of the virtual networks at the start time of the network attack, and
reducing the number of resources based on the determined resource amount.

5. The scaling method according to claim 1, wherein the reducing of the number of resources includes:
identifying, from the one or more first virtual networks, a plurality of virtual networks whose number of resources has increased in response to an increase in the traffic caused by the network attack, based on the notification,
extracting, from the plurality of virtual networks, one or more third virtual networks executed by a stateful application having state information for each communication session, and
reducing a number of resources allocated in the one or more physical servers for the extracted one or more virtual networks.

6. The scaling method according to claim 5, wherein
the notification includes time information indicating a start time of the network attack, and
the reducing of the number of resources includes:
extracting, from virtual machines or containers included in the one or more third virtual networks, one or more virtual machines or containers that have been added to the one or more first virtual networks after the start time when an effective time of state information held by the extracted one or more virtual networks is longer than an elapsed time from the start time, and
shortening an effective time of the extracted one or more virtual machines or containers.

7. The scaling method according to claim 5, wherein the reducing of the number of resources includes:
the notification includes time information indicating a start time of the network attack, and
the reducing of the number of resources includes:
extracting, from virtual machines or containers included in the extracted one or more third virtual networks, one or more virtual machines or containers whose ratio of a number of pieces of state information deleted as a result of the effective time having elapsed to a number of all pieces of state information is higher than or equal to a predetermined value when the effective time of the state information held by the extracted one or more virtual networks is shorter than or equal to an elapsed time from the start time, and
shortening an effective time of the extracted one or more virtual machines or containers.

8. A management device that manages a virtual network formed in a physical server, the management device comprising:
a memory; and
a processor coupled to the memory and configured to:
receive a notification on a network attack from a second virtual network that defends against the network attack and that is provided in a front stage of one or more first virtual networks, and
reduce a number of resources allocated in the one or more physical servers for the one or more first virtual networks when the notification is received.

9. The management device according to claim 8, wherein the processor is configured to:
reduce the number of resources allocated in the one or more physical servers for the virtual networks after a lapse of a first time after traffic of an object to be processed by the virtual network reduces, and
reduce the number of resources after the traffic of the object to be processed by the one or more first virtual networks reduces when the notification is received.

10. The management device according to claim 8, wherein the processor is configured to:
identify, from the one or more first virtual networks, a plurality of virtual networks whose number of resources has increased in response to an increase in the traffic caused by the network attack, based on the notification,
extract, from the a plurality of virtual networks, one or more virtual networks executed by a stateless application having no state information for each communication session, and
reduce a number of resources allocated in the one or more physical servers for the extracted one or more virtual networks.

11. The management device according to claim 10, wherein
the notification includes time information indicating a start time of the network attack, and
the processor is configured to:
determine a resource amount which is to be reduced for the extracted one or more virtual networks based on a resource amount or a traffic processing amount of the virtual networks at the start time of the network attack, and
reduce the number of resources based on the determined resource amount.

12. The management device according to claim 8, wherein the processor is configured to:
identify, from the one or more first virtual networks, a plurality of virtual networks whose number of resources has increased in response to an increase in the traffic caused by the network attack, based on the notification,
extract, from the one or more virtual networks, one or more third virtual networks executed by a stateful application having state information for each communication session, and
reduce a number of resources allocated in the one or more physical servers for the extracted one or more virtual networks.

13. The management device according to claim 12, wherein
the notification includes time information indicating a start time of the network attack, and
the processor is configured to:
extract, from virtual machines or containers included in the one or more third virtual networks, one or more virtual machines or containers that has been added to the one or more first virtual networks after the start time when an effective time of state information held by the extracted one or more virtual networks is longer than an elapsed time from the start time, and
shorten an effective time of the extracted one or more virtual machines or containers.

14. The management device according to claim 13, wherein
the notification includes time information indicating a start time of the network attack, and
the processor is configured to:
extract, from virtual machines or containers included in the virtual networks, one or more virtual machines or containers whose ratio of a number of pieces of state information deleted as a result of the effective time having elapsed to a number of all pieces of state information is higher than or equal to a predetermined value when the effective time of the state information held by the extracted one or more virtual networks is shorter than or equal to an elapsed time from the start time, and
shorten an effective time of the extracted one or more virtual machines or containers.
